(19) United States
(12) Patent Application Publication
(10) Pub. No.: US 2002/0188860 A1
(43) Pub. Date: Dec. 12, 2002

(54) Automatic electronic identification self-check

(76) Inventors: Travis J. Parry, Boise, ID (US); Robert Sesek, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/880,399

(22) Filed: Jun. 12, 2001

(51) Int. Cl. G06F 11/30

(52) U.S. Cl. 713/200

(57) ABSTRACT

This invention relates to automatically checking labels for consumables, such as marking agent cartridges. Such structures of this type, generally, allow a customer to determine if the installed marking agent cartridge is a counterfeit cartridge by automatically verifying the authenticity of the cartridge against the producer's/supplier's database. The marking agent could be, but is not limited to, toner, ink or the like.

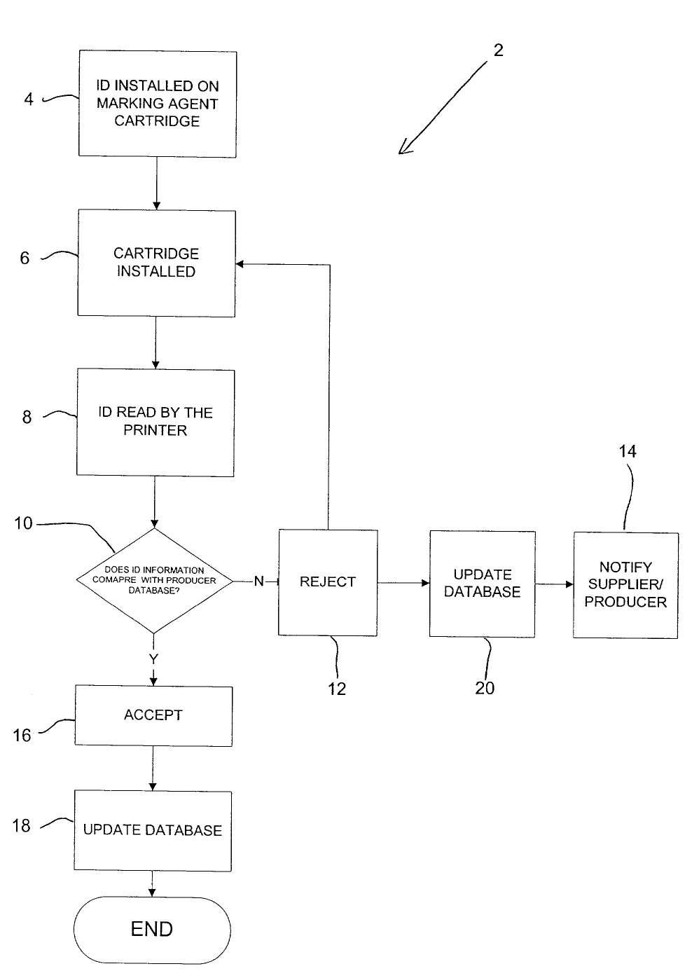

### FIELD OF THE INVENTION

This invention relates to automatically checking labels for consumables, such as marking agent cartridges. Such structures of this type, generally, allow a customer to determine if the installed marking agent cartridge is a counterfeit cartridge by automatically verifying the authenticity of the cartridge against the producer's/supplier's database. The marking agent could be, but is not limited to, toner, ink or the like.

### DESCRIPTION OF THE RELATED ART

It is known, in counterfeit detection apparatus, to employ a code or label. Exemplary of such prior art are U.S. Pat. No. 4,463,250 ('250) to D. L. McNeight et al., entitled “Method and Apparatus for Use Against Counterfeiting” and U.S. Pat. No. 6,069,955 ('955) to D. Coppersmith et al., entitled “System for Protection of Goods Against Counterfeiting.” While the '250 and '955 references employ codes/labels to detect counterfeiting, the codes/labels are not compared with a “master” list. Consequently, counterfeit merchandise still could be produced, if the counterfeiters were able to obtain/manufacture the secret code/label upon which these apparatus are based or were to simply reuse the code or label from a genuine article that has been depleted.

It is also known, in counterfeit detection apparatus, to employ a “master” list. Exemplary of such prior art are U.S. Pat. No. 3,833,795 ('795) to A. Shoshani et al., entitled “Method and Means for Ascertaining the Authenticity of Serially Numbered Objects” and U.S. Pat. No. 5,367,148 ('148) to L. Storch et al., entitled “Counterfeit Detection Using ID Members With At Least One Random Portion.” While the '795 and '148 references disclose an apparatus wherein a product is detected by checking associated identification numbers against a “master” list, none of the references complete this process automatically. Consequently, a further advantageous counterfeit detection apparatus, then, would be presented if the apparatus performed the counterfeit detection automatically when the consumable, such as a marking agent cartridge, was installed in the printer.

It is apparent from the above that there exists a need in the art for a counterfeit detection apparatus which is capable of detecting a counterfeit consumable, such as a marking agent cartridge, and which at least equals the counterfeit detection characteristics of the known apparatus, particularly those which employ a “master” list, but which at the same time is capable of performing the counterfeit detection automatically. It is a purpose of this invention to fulfill this and other needs in the art in a manner more apparent to the skilled artisan once given the following disclosure.

### SUMMARY OF THE INVENTION

Generally speaking, this invention fulfills these needs by providing a method for self-authenticating a marking agent cartridge, comprising the steps of: installing an identification means on a marking agent cartridge; installing the cartridge in a printer; automatically reading the identification means on the cartridge by the printer; determining if the cartridge is a counterfeit; and, accepting/rejecting the cartridge.

In certain preferred embodiments, the marking agent is toner, ink or the like. Also, the step of installing an identification means on the marking agent cartridge further includes the step of providing a database with information about the identification means. Also, the step of determining if the cartridge is counterfeit is further comprised of the step of comparing the identification means on the marking agent cartridge with information in the database about that particular cartridge. Finally, the method could include the step of updating the producer/supplier database once the cartridge was accepted/rejected.

In another further preferred embodiment, if the identification on the installed marking agent cartridge agrees with the information located in the database for that particular cartridge, the customer can be assured that the cartridge is genuine.

The preferred method, according to this invention, offers the following advantages: excellent counterfeit detection characteristics; reduced likelihood of reproduction; excellent economy; good stability; and good durability. In fact, in many of the preferred embodiments, these factors of counterfeit detection and likelihood of reproduction are optimized to the extent that is considerably higher than heretofore achieved in prior, known counterfeit detection methods.

The above and other features of the present invention, which will become more apparent as a description proceeds, are best understood by considering the following detailed description in conjunction with the accompanying FIGURE and in which:

### BRIEF DESCRIPTION OF THE DRAWING

The FIGURE is a flowchart that illustrates a method for self-authenticating a marking agent cartridge, according to one embodiment of the present invention.

### DETAILED DESCRIPTION OF THE INVENTION

With reference first to the FIGURE, there is illustrated one preferred embodiment for use of the concepts of this invention. Method 2 for self-authenticating a marking agent cartridge is shown. Method 2 includes, in part, the steps of installing an identification means on the marking agent cartridge 4, conventionally installing the cartridge 6, conventionally reading/scanning the identification means by the printer 8, comparing the information read by the printer with a producer/supplier database 10, rejecting the cartridge if the cartridge is found to be counterfeit 12, notifying the producer/supplier of the counterfeit cartridge 14, accepting the cartridge as being genuine 16, if the identification information in the database matches the information on the cartridge, and updating the producer/supplier database 18,20.

The step 4 of installing the identification means can be a conventional one. Also, the identification means can be, but is not limited to, a bar code, a label or the like which are conventionally located on or embedded in the marking agent cartridge. It is to be understood that the phrase “marking agent” can refer to, but is not limited to, toner, ink or the like. It is also to be understood that whatever type of identification means is used, information contained within the identification means is conventionally forwarded to a producer/supplier database in order to compile a “master” list. In this manner, the producer and/or supplier can keep track of the marking agent cartridges produced to ensure that only genuine marking agent cartridges produced by the producer and/or sold by the supplier are being used by the customer. Finally, it is to be understood that the term “consumable” refers to any article that can be replaced in a printer/printing device and is capable of retaining a label.

With respect to the step 10 of comparing the information read by the printer with the producer/supplier database, after the marking agent cartridge is installed in the printer, the printer automatically reads/scans the identification means and obtains information from that identification means which is indicative of the marking agent cartridge. The printer then interacts with the producer/supplier database and “master” list to determine if that particular marking agent cartridge is genuine. For example, if a marking agent cartridge is given the number (555) prior to being shipped and the printer reads (555) on the marking agent cartridge that was just installed, then the customer can be assured that the marking agent cartridge is genuine. However, if that same marking agent cartridge was given the number (555) prior to being shipped and was later discarded because the marking agent was exhausted and reported back to the producer/supplier as being exhausted, if a subsequently installed marking agent cartridge was read by the printer to also have the number (555), then the database would alert the customer that this subsequently installed marking agent cartridge was a counterfeit.

After it is determined that the marking agent cartridge is not genuine, the customer can reject that counterfeit marking agent cartridge, as shown in step 12, and install a different marking agent cartridge, as shown in step 6. As an alternative, the printer may automatically notify the producer/supplier if the marking agent cartridge is counterfeit, as shown in step 14. Also, the producer/supplier database is updated, as shown in steps 18,20, to reflect that the particular cartridge has been accepted or rejected. It is to be understood that the database could also be updated, for example, with the number of pages printed and the remaining marking agent level in the cartridge when the marking agent level reaches a set point. This allows for detection of refilled cartridges.

If the information from that identification means on the installed marking agent cartridge matches the information for that particular marking agent cartridge located in the database, the customer can be conventionally notified that the installed marking agent cartridge is genuine.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. A method for self-authenticating a marking agent cartridge, wherein said method is comprised of the steps of:
installing an identification means on a marking agent cartridge;
installing said cartridge in a printer;
automatically reading said identification means on said cartridge by said printer;
determining if said cartridge is a counterfeit; and accepting/rejecting said cartridge.

2. The method, as in claim 1, wherein said marking agent is further comprised of:
toner.

3. The method, as in claim 1, wherein said marking agent is further comprised of:
ink.

4. The method, as in claim 1, wherein said identification means is further comprised of:
a bar code.

5. The method, as in claim 1, wherein said identification means is further comprised of:
a label.

6. The method, as in claim 1, wherein said step of installing an identification means on said marking agent is further comprised of the steps of:
forwarding first information regarding said identification means to a database; and
compiling said first information in said database.

7. The method, as in claim 6, wherein said determining step is further comprised of the steps of:
automatically reading said identification means on said cartridge by said printer in order to obtain second information regarding said identification means; and
comparing said first information of said identification means with said second information of said identification means.

8. The method, as in claim 7, wherein said accepting/rejecting step is further comprised of the steps of:
accepting said marking agent cartridge as being genuine if said first information of said identification means substantially matches said second information of said identification means; and
rejecting said marking agent cartridge as being counterfeit if said first information of said identification means does not substantially match said second information of said identification means.

9. The method, as in claim 1, wherein said method is further comprised of the step of:
notifying a producer/supplier of said marking agent cartridge if said marking agent cartridge is rejected as being counterfeit.

10. A method for self-authenticating a marking agent cartridge, wherein said method is comprised of the steps of:
installing an identification means on a marking agent cartridge; installing said cartridge in a printing device;
automatically reading said identification means on said cartridge by said printing device;
determining if said cartridge is a counterfeit; and
accepting/rejecting said cartridge.

11. The method, as in claim 10, wherein said marking agent is further comprised of:
toner.

12. The method, as in claim 10, wherein said marking agent is further comprised of:
ink.

13. The method, as in claim 10, wherein said identification means is further comprised of:
a bar code.

14. The method, as in claim 10, wherein said identification means is further comprised of:
a label.

15. The method, as in claim 10, wherein said step of installing an identification means on said marking agent is further comprised of the steps of:
forwarding first information regarding said identification means to a database; and
compiling said first information in said database.

16. The method, as in claim 15, wherein said determining step is further comprised of the steps of:
automatically reading said identification means on said cartridge by said printing device in order to obtain second information regarding said identification means; and
comparing said first information of said identification means with said second information of said identification means.

17 The method, as in claim 16, wherein said accepting/rejecting step is further comprised of the steps of:
accepting said marking agent cartridge as being genuine if said first information of said identification means substantially matches said second information of said identification means; and
rejecting said marking agent cartridge as being counterfeit if said first information of said identification means does not substantially match said second information of said identification means.

18. The method, as in claim 10, wherein said method is further comprised of the step of:
notifying a producer/supplier of said marking agent cartridge if said marking agent cartridge is rejected as being counterfeit.
